(19) United States
(12) Patent Application Publication
(10) Pub. No.: US 2022/0206181 A1
(43) Pub. Date: Jun. 30, 2022

(54) SUBMERSIBLE SENSING SYSTEM FOR WATER AND SEDIMENT MONITORING

(71) Applicant: KING ABDULLAH UNIVERSITY OF SCIENCE AND TECHNOLOGY, Thuwal (SA)

(72) Inventors: Juan Carlos SANTAMARINA, Thuwal (SA); Marco TERZARIOL, Thuwal (SA); Jiming JIANG, Thuwal (SA)

(21) Appl. No.: 17/604,026

(22) PCT Filed: Mar. 17, 2020
(86) PCT No.: PCT/IB2020/052432

§ 371 Date: Oct. 15, 2021

Related U.S. Application Data
(60) Provisional application No. 62/839,221, filed on Apr. 26, 2019.

(51) Int. Cl. G01V 11/00

(52) U.S. Cl. CPC G01V 11/002

(57) ABSTRACT

A hybrid, modularized, tailored and re-configurable distributed monitoring and characterization device for bodies of water and sediments, including oceans, lakes, rivers, and water reservoirs. The device includes individual nodes, which are deployed as either a stand-alone or networked system. Each node is a multi-physics and multi-purpose piece of equipment with electronics and sensors configured into different modules which interconnect similar to building blocks. The device provides two housing options: a hard shell housing option for shallow water and an oil-filled soft shell housing scheme for deep water.

### CROSS-REFERENCE TO RELATED APPLICATIONS

This application claims priority to U.S. Provisional Patent Application No. 62/839,221, filed on Apr. 26, 2019, entitled “HYBRID MINIATURE SUBMERSIBLE SENSING PLATFORM FOR OCEAN AND SEAFLOOR MONITORING,” the disclosure of which is incorporated herein by reference in its entirety.

### BACKGROUND

### Technical Field

Embodiments of the subject matter disclosed herein generally relate to a system for monitoring one or more parameters associated with a body of water, and more particularly, a hybrid, modularized, tailored and re-configurable distributed monitoring and characterization system for bodies of water and sediments below, including oceans, lakes, rivers, and water reservoirs.

### Discussion of the Background

About 70% of the Earth's surface is covered by water yet only 5% is explored (albeit with very low resolution) and the remaining 95% is virtually unexplored. However, the ocean is critical to human lives as it provides food, marine highways for goods and information, regulates the global climate and local weather, and acts as both a storage and sink for natural and man-made, on-shore and off-shore, products.

Sea pollution has become a major concern in recent years and is frequently associated with fisheries, off-shore mining, and waste disposal from cities and industries. Yet, the monitoring systems for all of these cases is very poor or non-existent. This is so due to a couple of reasons. Current commercial monitoring systems are bulky, e.g., they require special vessels for deployment and recovery [1], [2], or they are expensive, for example, the cost of such a system is over 100M USD for construction and operation [3]. Further, the existing systems are typically limited to single-point operations, which makes them very inflexible, or are difficult to deploy.

Thus, there is a need for a new hybrid, modularized, tailored and re-configurable, distributed monitoring and characterization system that is appropriate for any body of water, is easy to launch, and is not expensive to maintain and operate.

### BRIEF SUMMARY OF THE INVENTION

According to an embodiment, there is a system for collecting ocean data and the system includes a node having one or more sensors for collecting the ocean data; a hard shell housing configured to receive the node; and a soft shell housing configured to receive the node. The node is placed into an interior chamber of the hard shell housing for shallow waters operations and the node is placed into an interior chamber of the soft shell housing filled with a dielectric liquid for deep waters operation.

According to another embodiment, there is a method for collecting ocean data, and the method includes configuring a node with one or more sensors for collecting the ocean data; selecting, based on a water depth at which the node operates, a hard shell housing for shallow water operation, and a soft shell housing for deep water operation; attaching the node to an internal chamber of the selected hard shell housing or the soft shell housing; deploying the node in the water; and collecting the ocean data with the one or more sensors.

### BRIEF DESCRIPTION OF THE DRAWINGS

For a more complete understanding of the present invention, reference is now made to the following descriptions taken in conjunction with the accompanying drawings, in which:

FIG. 1 is a schematic diagram of a node for collecting ocean data;

FIG. 2 is a schematic diagram of an electrical connector between various boards of the node;

FIG. 3 is an overview image of the node having four electronic boards;

FIG. 4 is a schematic diagram of electronic boards and their connections;

FIG. 5 illustrates a hard shell housing having two halves;

FIG. 6 shows the hard shell housing holding the node;

FIGS. 7A to 7D illustrate how the hard shell housing is assembled prior to water deployment;

FIG. 8 illustrates a soft shell housing that is used for deep water deployment of the node;

FIGS. 9A to 9G illustrate how the soft shell housing is assembled prior to ocean deployment;

FIG. 10 is a method for selecting a housing for a node depending on the depth of water operations, and collecting the ocean data;

FIG. 11 schematically illustrates how to configure the node based on software instructions from a user's device;

FIG. 12 illustrates a system in which a mother vessel launches plural nodes to collect the ocean data; and

FIGS. 13A and 13B illustrate various ocean data collected with the node.

### DETAILED DESCRIPTION OF THE INVENTION

The following description of the embodiments refers to the accompanying drawings. The same reference numbers in different drawings identify the same or similar elements. The following detailed description does not limit the invention. Instead, the scope of the invention is defined by the appended claims. The following embodiments are discussed, for simplicity, with regard to a system that uses four different processing boards stacked inside a shell and connected to each other with a universal electrical connector/bus. However, the embodiments to be discussed next are not limited to four processing boards, but may implemented with another number of processing boards.

Reference throughout the specification to “one embodiment” or “an embodiment” means that a particular feature, structure or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

According to an embodiment, a hybrid, modularized, tailored and re-configurable, distributed monitoring and characterization node has the capability to assess and record both natural and man-made processes. The multi-physics and multi-purpose equipment placed inside the node includes electronics and sensors configured into different modules, which interconnect similar to building blocks. In one application, a software is run from the user's computing device for configuring which component to be active in the node. Firmware operates from a microprocessor embedded into the hardware present in the node. Thus, the unique software and firmware co-design of the node provides the user with the ability to re-configure the equipment present inside the node to meet his/her individual needs.

An advantage of the node noted above with respect to others in the market and academic projects, is the fact that it can be deployed in shallow and deep waters, and for this reason this node is called a “hybrid” node. As discussed later, the node can be watertight at 1 atmosphere for shallow applications, or it can be filled with a dielectric liquid (e.g., paraffin oil) in order to subject it to high-water depths. For the high-water depths, the electronics, connectors, batteries and sensors that form the node are pressurized to the maximum water pressure without losing reliability of the data gathered.

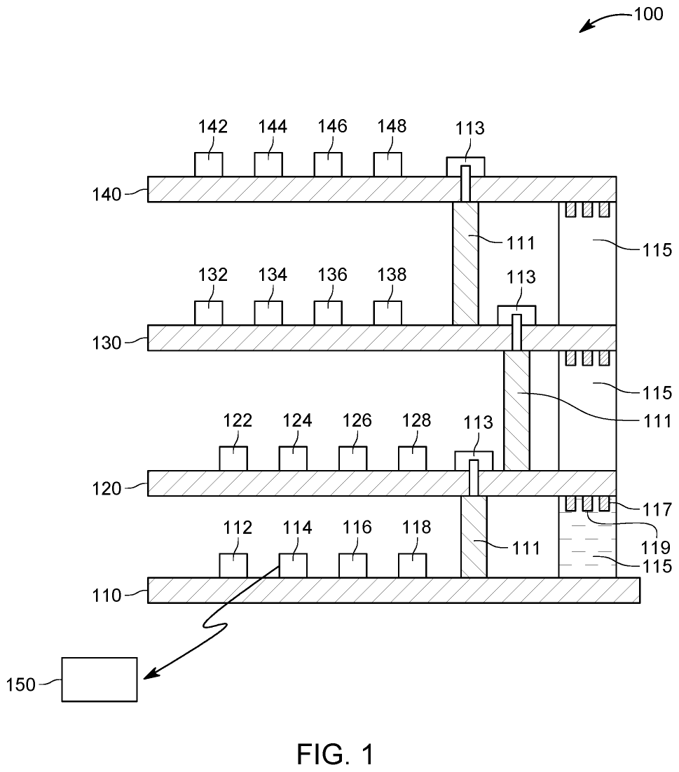

Such a node 100 is illustrated in FIG. 1 having four electronic boards 110, 120, 130, and 140 attached to each other to form a single, compact structure. In this specific implementation, the first electronic board 110 is a communication board that includes a global positioning system (GPS) 112, a wireless communication module 114, and a satellite communication module 116. The wireless communication module 114 may be configured to use electromagnetic waves, for example, short-wavelengths for Bluetooth communication, or long-wavelength for radio communication, and/or acoustic waves for acoustic communication. The satellite communication module 116 is configured to communicate via satellite with the operator of the node for situations when the node surfaces from an underwater assignment and its position needs to be determined. A computing device 118 (for example, including processor and memory) is also located on the first electronic board 110 for coordinating the previously discussed elements.

The first electronic board 110 also has a mechanical connector 111 and an electrical connector 115. The mechanical connector 111 may include one or more poles that extend from the board vertically upwards, and are configured to be attached, for example, with a nut 113 to a next electronic board 120. For example, an end of the mechanical connector 111 may be threaded and configured to enter a matching hole formed into the second electronic board 120. Then, the nut 113 is added to the threaded end to fix the second electronic board 120 to the first electronic board 110. More poles may be distributed between the two electronic boards to distribute the forces acting on the boards equally. In another application, the mechanical connector 111 has just a clamp that clamps to a corresponding portion in the next electronic board and thus, no threads and nuts are necessary. In one embodiment, each mechanical connector is fixedly attached to a corresponding board with a first end, and the other end is configured to be attached to an adjacent board. The same configuration for the mechanical connector is used for all the boards.

The electrical connector 115 (or bus) also extends vertically upwards, from the first electronic board toward the second electronic board, and is fixedly attached to the first electronic board 110. The electrical connector 115 has one or more holes 117 that are configured to mate with corresponding pins 119, that are electrically connected to the second electronic board 120. The number of pins and holes depends on the specific implementation of the node 100. However, after a specific implementation of the electrical connector is selected, the same configuration is used to connect all the boards so that the boards are interchangeable.

For example, in one embodiment, it is possible to have 16 pins for each electrical connector 115. Note that there is a single electrical connector 115 between any pair of adjacent electronic boards and the electrical connector is fixedly attached to its corresponding electronic board at the same location, so that the electronic boards are interchangeable with each other. The same is true for the mechanical connector 111. This means that the second electronic board 120 can be added on top of the first electronic board as shown in FIG. 1, or, in another embodiment, the first electronic board is added on top of the second electronic board.

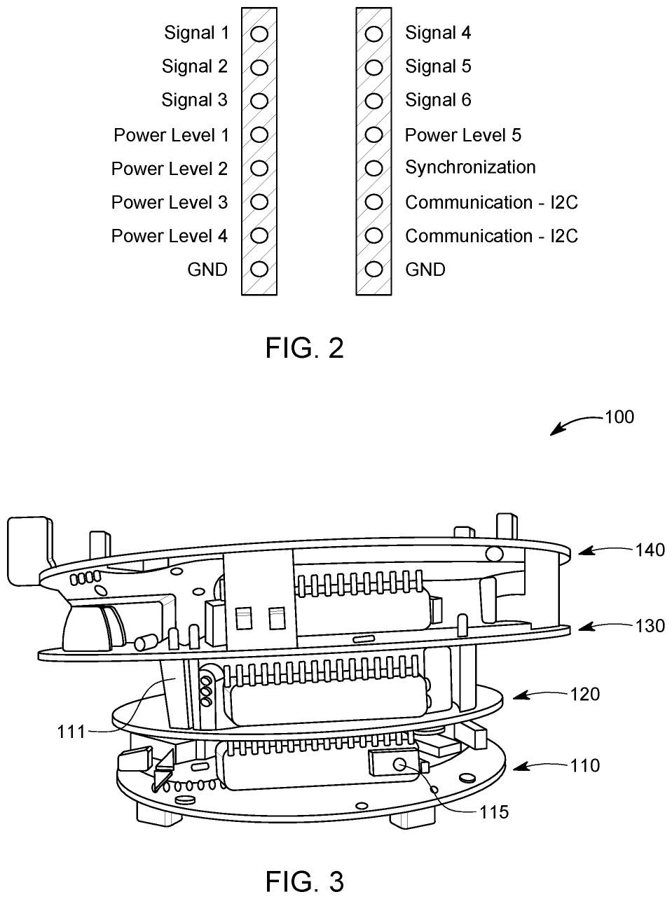

Returning to the electrical connector 115, a configuration with 16 pins is illustrated in FIG. 2 and the entire node is illustrated in FIG. 3. FIG. 2 shows the electrical connector 115 having five power pins PL1 to PL5, two ground pins GND, one synchronization pin S, two communication pins C1 and C2, and 6 analog signal pins. The different power levels are necessary as the various sensors that are present in the node, as will be discussed later, have different purposes and thus, different voltage needs. The synchronization pin S is used to synchronize the computing devices of each electronic board with the others, and the communication pins C1 and C2 are used for inter-electronic board communication, but also for transmitting commands to one or more of the computing devices, or collecting the measured data from the sensors. Six analog signal pins are used for transmitting control signals or analog signals between one or more boards. One skilled in the art would understand that more or less pins are possible for the power level, synchronization, control and the communication purposes. However, once the number of pins for a node is selected, all the electronic boards have the same number of pins so that the boards are interchangeable.

Returning to FIG. 1, the second electronic board 120 includes power related modules and for this reason this board is also called the power board. The second electronic board 120 includes a power source 122, which may be an electrical battery, a fuel cell, or any other source of energy. The electrical energy supplied by the power source 122 is adjusted by a power regulator 124 in order to provide the right amount of voltage and/or current to a desired power pin of its own electrical connector 115. Further, the second electronic board 120 may include a computing device 126 for regulating all these elements and, optionally, an additional power source 128, which may be of a different or the same type as the main power source 122.

A third electronic board 130 is attached with the mechanical connector 111 and the electrical connector 115 to the second electronic board 120, as also shown in FIG. 1. The third electronic board 130 may be a digital board, i.e., a board that is configured to support one or more digital sensors 132. The digital sensors 132 may be directly attached to the board as shown in the figure, or they may be attached to a housing that encloses the node, as discussed later. For example, a pressure sensor needs to have access to the ambient of the housing, and for this reason it would be attached outside of the housing. If the sensor is attached to the outside of the housing, then element 132 represents the digital interface associated with the sensor. The digital sensor 132 may include one or more of a temperature sensor, a digital electrical conductivity module, an audio codec, accelerometer, gyroscope, magnetometer, pressure sensor, and a digital interface. This interface further extends the sensing capability of the equipment to allow for a large number of attachments to be added to the corresponding board.

In addition, the third electronic board may have a digital processing unit 134, a computing device 136, and a communication hub 138. The digital processing unit 134 is configured to process the data recorded by the digital sensors, the computing device 136 is configured to coordinate with the other electronic boards, for example, how much power can use and when to transmit the processed data, and the communication hub 138 connects to the electrical connector 115 and transmits and receives various packets of data between the various computing devices of the plural electronic boards.

Similar to the digital electronic board 130, an analog electronic board 140 is also provided in the module. The analog electronic board 140 is attached with a mechanical connector 111 and an electronic connector 115 to the third electronic board 130. The analog electronic board 140 can include one or more analog sensor 142. Similar to the digital sensor 132, the analog sensor 142 may be located directly on the board or on the housing of the node, as discussed later. The analog sensor 142 may include one or more of an analog processing unit, pressure sensor, hydrophone, pH and turbidity sensors, geophones, and shear accelerometers. The analog electronic board 140 may also include an analog processing unit 144, a computing device 146, and a communication hub 148, that have the same or similar functionalities as the elements of the digital electronic board 130.

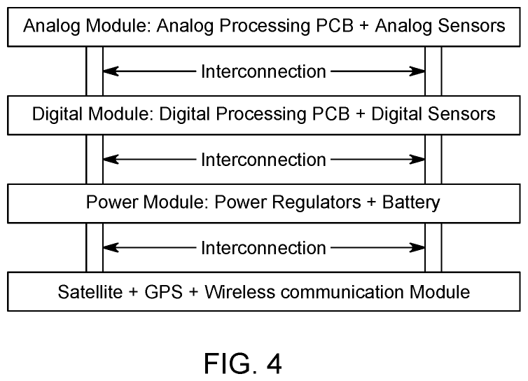

The actual substrate of each electronic board may be a printed circuit board, for providing physical support to the elements discussed above, but also electrical connections between these elements and the electrical connectors 115. Other materials may be used as would be understood by those skilled in the art. FIG. 4 schematically illustrates the various electronic boards of the node 100, the same type of mechanical connectors 111 and electrical connectors 115 connecting the boards to each other, and also the fact that one type of board, for example, the analog and the digital boards 130 and 140 in this example, can include in fact plural boards stacked on top of each other. In one application, there are no wires extending between these boards except for the electrical connectors 115, which are identical to each other. This configuration makes the node 100 highly adjustable, modular, and reconfigurable. Also, the operator of the node can remove or add more electronic boards with attached desired sensors, depending on the application. This feature offers to the various operators of the node the capability to tailor the node to fit to the job on hand. In other words, the node discussed above may have any number, between zero and 100, of analog and digital boards, depending on what parameters or quantities need to be monitored. In one configuration, no analog board is present, while in another configuration, no digital board is present.

In one application, the computing devices 118, 128, 138, and 148 may be used to adapt/configure their respective electronic boards based on commands sent from the user of the node. For example, the user of the node may employ an external computing device 150, as shown in FIG. 1, to communicate in a wireless manner with the wireless communication module 114 of the first electronic board 110. The external computing device 150 may transmit commands to the computing device 138 to turn off all the digital sensors 132 of the digital board 130, or to cut power to the entire digital board 130. Other commands may be transmitted to the digital board or to any board of the node 100. The computing devices 118, 128, 138, and 148 may be configured to run the same software as the external computing device 150 so that the user can reconfigure the boards and their components in any desired way.

Depending on whether the node 100 needs to be deployed in shallow waters or deep waters, an appropriate housing is provided. In the following, the term “shallow waters” means a depth between 0 and 1,000 m relative to the water surface while the term “deep waters” means a depth larger than 1,000 m. For each situation, a different housing will be used. For example, for the shallow waters scenario, a hard shell housing is used while for the deep waters scenario, a soft shell housing is used. Irrespective of the scenario, the same node 100 is placed in the selected housing. Thus, both the soft shell housing and the hard shell housing are configured to accommodate the same node 100. The two housings are now discussed.

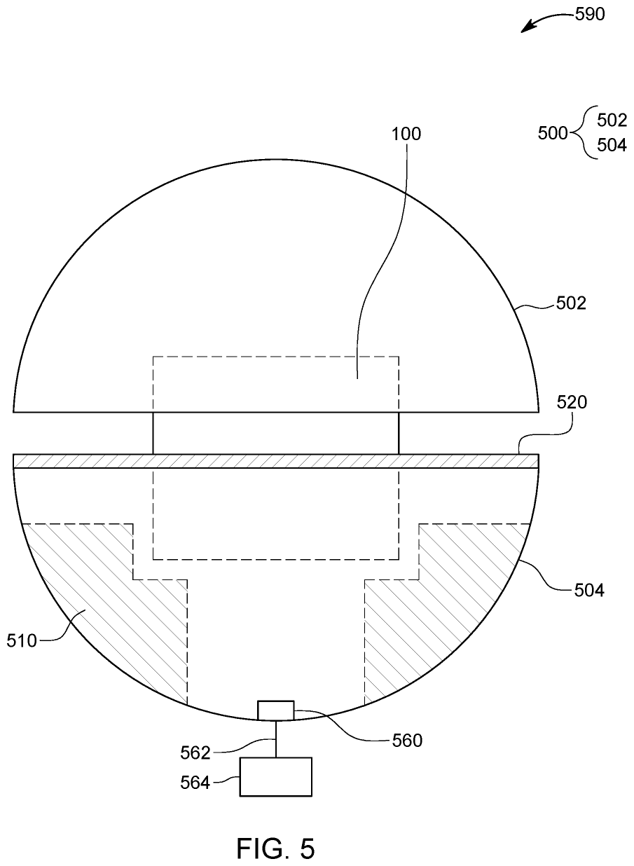

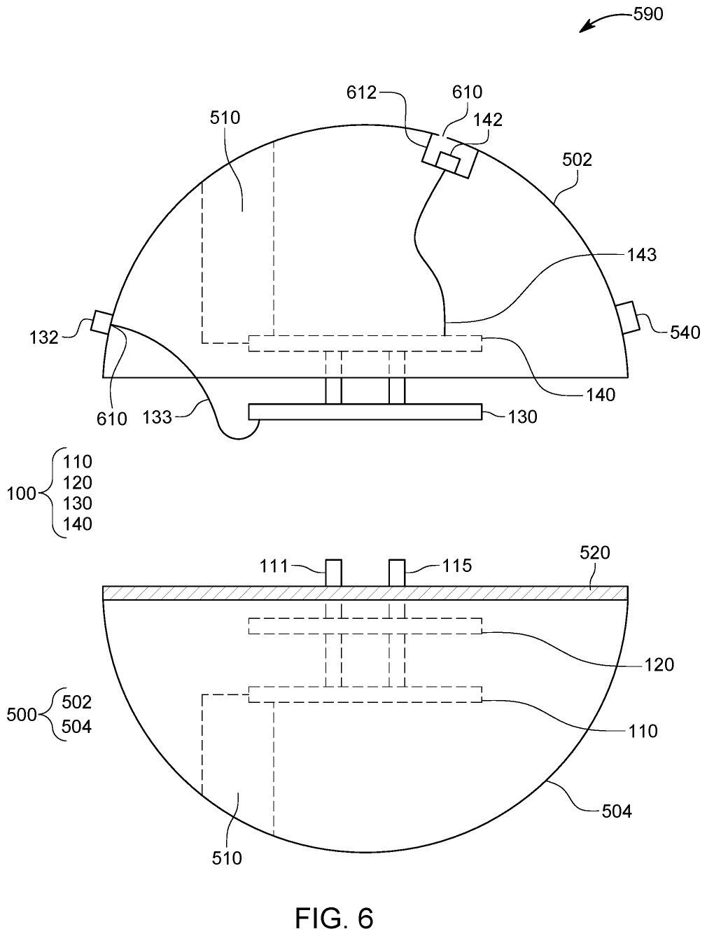

FIG. 5 shows the hard shell housing 500 being made of two halves 502 and 504, that when assembled into a single structure, have a spherical shape. In one embodiment, the shape is different from spherical, e.g., ovoid, oblong, or like a clam shell. The hard shell housing is made of a metal or a composite material that is rigid. At least one of the half shells 502 and 504 has a clamping system 510 for fixing the node 100 to the shell. The clamping system 510 may include, for example, one or more hooks that are configured to be attached to the first electronic board and then be secured with a drum clamp, push-pull clamp, latch clamp, or any other clamp. In one application, the half shells are attached to each other and then their interior is vacuumed to make the two shells to stay together. In one application, it is possible that each half shell has a clamping system 510, and a first subset of the electronic boards is attached to the first shell 502, and a second subset of the electronic boards is attached to the second shell 504, as shown in FIG. 6. Then, the two shells are closed and because the corresponding clamping systems are aligned, the most distal electronic board 130 of the shell 502 engages the most distal electronic board 120 of the shell 504, and due to the mechanical connector 111 discussed above, these two electronic boards are mechanically connected to each other. At the same time, the electrical connector 115 electrically connects the two electronic boards and the two shells electrically engage each other. However, note that a o-ring 520 made of rubber or another flexible material is present between the two hard shells 502 and 504 as illustrated in FIGS. 5 and 6. Those skilled in the art would understand that the first and second sub-sets may have any number of electronic boards.

If any of the sensors 132 or 142 needs to be in direct contact with the ambient water, such sensor can be mounted on the outside of the housing, directly on the shell, as shown in FIG. 6 by sensor 132, and a signal wire 133 can connect the sensor 132 to its corresponding electronic board 130. In this case, a port 610 is formed into the shell so that the signal wire 133 can be connected to the sensor outside the shell, and to the electronic board inside the shell. The port 610 is selected to be water tight. However, it is also possible to place an interior housing 612 inside the shell, around the port 610, as also shown in FIG. 6, and to place a sensor 142 inside the interior housing 612, and to attach a signal wire 143 between the sensor 142 and the corresponding electronic board 140. In this case, the interior housing 612 has a water tight port for allowing the signal wire 143 to pass through the wall of the interior housing while port 610 is open to the ambient water. If there is no need to have a sensor directly interact with the ambient, that sensor may be removed from the shell and the corresponding port 610 may be sealed to prevent the water to enter inside the housing. FIG. 6 also shows the presence of a connector 540, which is used to handling the housing during the deploying and retrieving operations. For example, the connector 540 can be a hook, or a magnet, or any means for hanging a rope to the housing.

Returning to FIG. 5, this figure shows a detaching mechanism 560 attached to the second shell 504. The detaching mechanism 560 is connected through a cable 562 to a weight 564. A weight of the weight 564 is calculated so that the system 590 including the node 100, the housing 500, and the weight 564 has an overall negative buoyancy, so that the entire assembly sinks to the ocean bottom. The detaching mechanism 560 may be electrically connected to one of the computing devices of the node 100, for example, computing device 128 of the power board 120. The computing device 128 may be configured to instruct the detaching mechanism 560 to release the cable 562 at a given time, or after a certain time, or based on an incoming signal received by the communication board 110 (for example, an acoustic signal sent from the water surface, from a mother vessel that will retrieve the node 100). In one embodiment, the entire detaching mechanism 560 may be configured to detach from the shell when instructed.

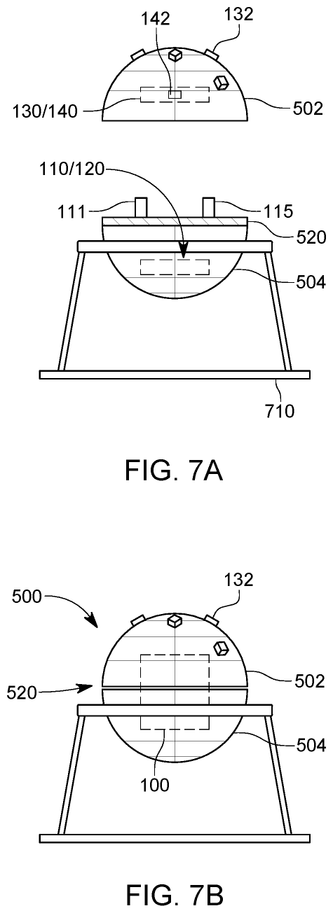

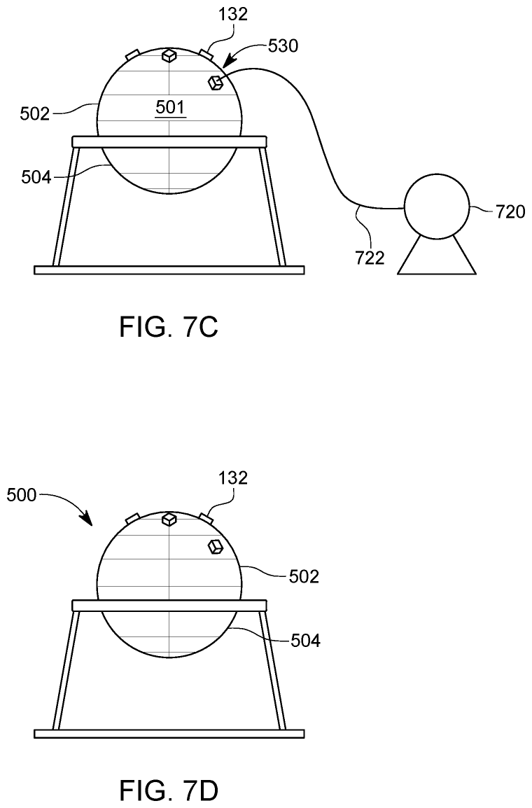

A method for assembling the hard shell housing 500 is now discussed with regard to FIGS. 7A to 7D. In this embodiment, there are some external sensors 132 placed on the first hard shell 502, but also some internal sensors 142 for measuring a movement of the housing. The internal sensors 142 may be geophones in this embodiment and they may be analog geophones, so that they are placed on or connected to the analog board 140. In this embodiment, the first and second electronic boards 110 and 120 are clamped to the second hard shell 504 while the digital and analog electronic boards 130 and 140 are clamped to the first hard shell 502, as illustrated in FIG. 7A. To promote the coupling of the first hard shell to the second hard shell, the second hard shell may be supported by a working frame 710, as also shown in FIG. 7A. Next, the first hard shell 502 is placed over the second hard shell 504 so that the electrical connector 115 of the second electronic board electrically engages the third electronic board, and the mechanical connector 111 of the second electronic board mechanically engages the third electronic board. It is also possible that the electrical connection between the second and third electronic boards is achieved with wires that are manually attached to these boards by the operator of the node, just prior to closing the two hard shells 502 and 504. No mechanical connector is needed between the second and third boards in this case if each shell has its own clamping system 510 for holding in place the corresponding sub-set of electronic boards.

The two hard shells 502 and 504 are then mated together, as illustrated in FIG. 7B. A gap between the two hard shells is visible in this figure and this is so because of the o-ring 520 that is sitting between the rims of the two shells. To fully close the node 100 within the housing 500, a vacuum pump 720 is connected through a tube 722 to a vacuum port 530 formed in the wall of one of the first or second hard shells 502 and 504, as illustrated in FIG. 7C. The vacuum port 530 may be, for example, a G-129 purge port from Global Ocean Design. Other types of ports may be used as long as they are able to maintain the vacuum inside the housing 500. An interior chamber 501 inside the housing 500 has now the air evacuated with the vacuum pump 720 and a pressure of up to −60 kPa may be established inside the interior chamber. When this happens, the gap shown in FIG. 7B disappears as the two hard shells press hard the o-ring between them. Note that the rims of the hard shells 502 and 504 may be formed as a tongue and groove mechanism so that the o-ring 520 is completely or almost completely located inside the groove, and thus barely visible or invisible from outside. The low pressure inside the interior chamber 501 shown in FIG. 7C maintains the two shells 502 and 504 closed together, so that there is no need for any exterior clamping or locking mechanism for securing together the halves of the housing 500. FIG. 7D shows in this regard the two halves 502 and 504 forming the housing 500 with no external locking mechanism. Those skilled in the art would understand that it is possible to add an external locking mechanism if necessary.

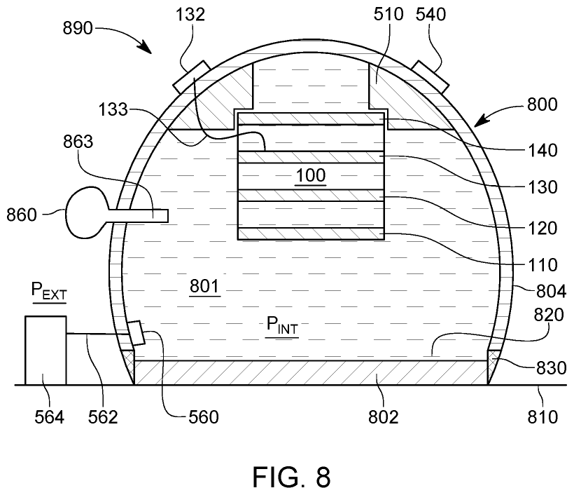

If the node 100 needs to be deployed in deep water, then a soft shell housing 800 is used, as illustrated in FIG. 8. The housing 800 has at least two parts, a flexible part 802 that is configured to contact the ocean bottom 810, and a top part 804 that is configured to offer structural support for the node 100. One skilled in the art would understand that the rigid part may contact the sediment while the flexible part may remain exposed to the water side. A clamping system 510, similar to that discussed above with regard to FIG. 5, may be attached to the top part 804 to hold in place the node 100. Note that the flexible part 802 is not in contact with the node 100 so that any pressure variation in the ambient water can freely be transferred, through the flexible part 802, to a liquid 820 that is present inside the housing 800. The top part 804 is attached to the flexible part 802 so that no water from the ambient enters the interior chamber 801. The flexible part 802 may be formed from rubber or other similar material that allows an exterior pressure Pext of the ambient to be transmitted to the interior chamber 801. The liquid 820 is provided inside the interior chamber 801 so that a pressure Pint of the fluid 820 has the same pressure as the ambient water, i.e., Pext=Pint. In this way, the pressure of the ambient is transmitted to the interior chamber 801 at any position of the housing 800. The liquid 820 is a dielectric fluid and it enters between the electronic board 110 to 140 so that each part of the node 100 is exposed to the liquid 820. The liquid 820 may be an oil. The top part 804 may be formed of a rigid material, for example, a metal, or by a flexible material, for example, a plastic or a composite material. Because the interior pressure is the same as the external pressure, there is no need for the top part 804 to withstand a high ocean bottom pressure.

As for the previous housing 500, those sensors, for example sensor 132, that need to interact directly with the ambient, may be located outside the top part 804, as shown in FIG. 8, and a signal wire 133 may enter the top part and be connected to the corresponding electronic board 130. A connector 540, similar to that shown in FIG. 6, may be attached to the outside of the top part 804, for allowing handling of the housing during deploying and retrieving operations. FIG. 8 also shows a fastening mechanism 830 (for example, screws, but other components may be used) that attaches the flexible part 802 to the top part 804. The detaching mechanism 560 shown in FIG. 5 may be attached to the top part 804. As in FIG. 5, the detaching mechanism 560 is connected through the cable 562 to the weight 564, and the weight of the weight 564 is calculated so that the entire system has a negative buoyancy. However, the system 890 shown in FIG. 8, without the weight 564, is designed to have a positive buoyancy, so that when the weight 564 is released, the system floats to the water surface so that a mother vessel can retrieve the node 100. If the system 890 shown in FIG. 8 has a negative buoyancy even after the weight 564 has been released, an empty bladder 860 may be inflated with compressed air stored in a can 862 so that the overall buoyancy of the system becomes positive, and the system can be retrieved from the surface by a mother vessel. The can 862 can be controlled by one of the computing devices from the boards.

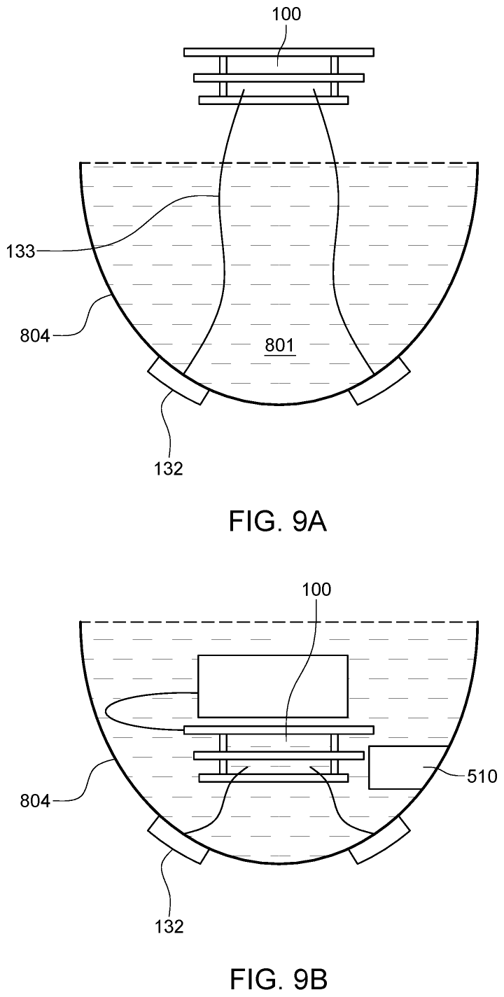

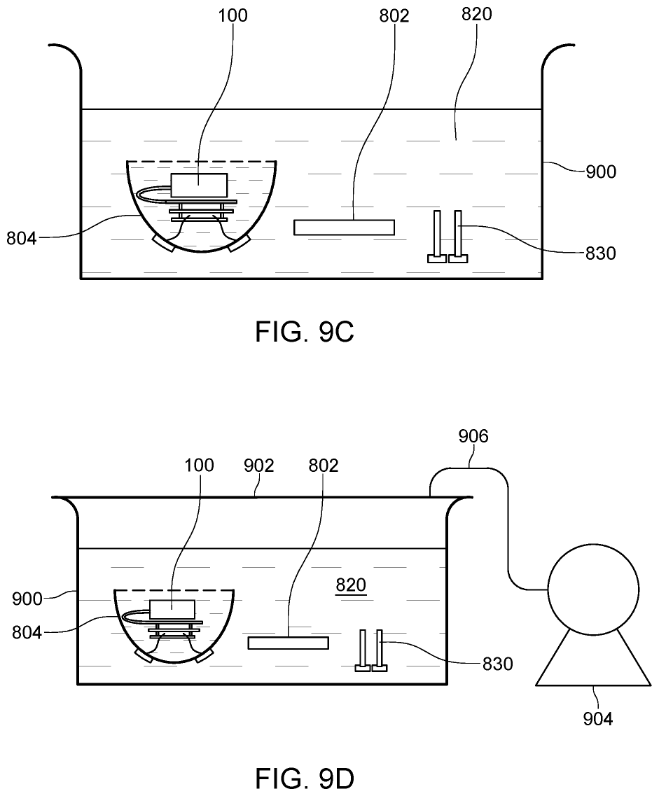

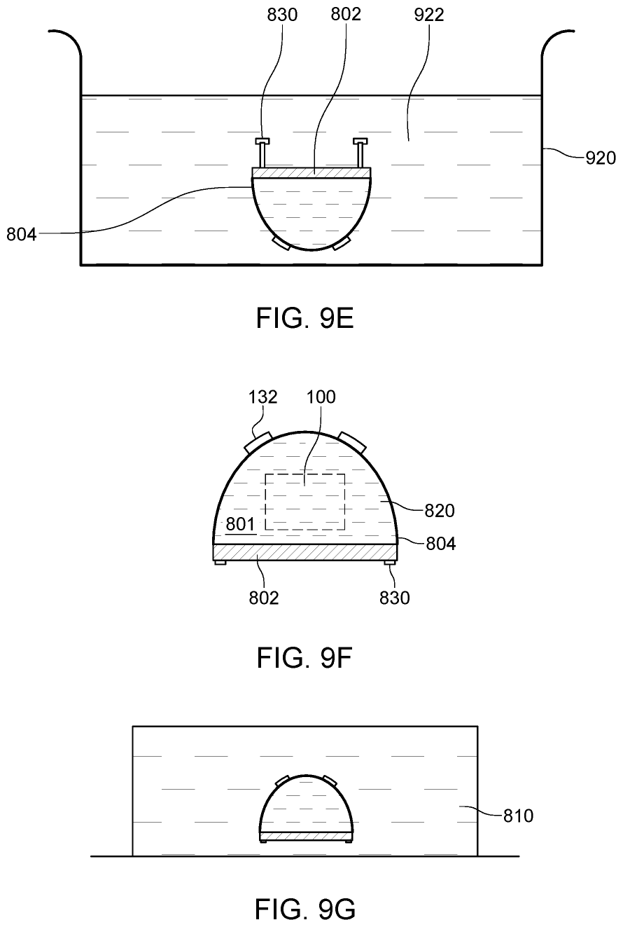

A method for preparing the node 100 for deep water deployment by using the housing 800 is now discussed with regard to FIGS. 9A to 9G. As shown in FIG. 9A, the node 100 is electrically connected to the external sensors 132 through corresponding signal wires 133. Note that if the configuration selected by the user does not involve any sensor being placed outside the housing 800, this step can be skipped. Next, as shown in FIG. 9B, the node 100 is placed inside the top part 804 and attached to the top part with the clamping system 510. Note that the flexible part 802 is not present at this stage. Then, the node 100, which is fixed to the top part 804, is immersed with the top part in a container 900, in which the liquid 820 is present. The flexible part 802 and the fastening mechanism 830 are also immersed into the liquid 820 in the container 900 as shown in FIG. 9C.

A lid 902 is added to the container 900, as shown in FIG. 9D, to seal the liquid 820 and the above noted components from the ambient air. A vacuum pump 904 is connected through a pipe 906 to the interior of the container 900 and the air from inside the container is removed to ensure full saturation in the liquid of the node 100, top part 804, flexible part 802, and the fastening mechanism 830. The vacuum may be maintained for an hour before the lid is removed, and the flexible part 802 is attached with the fastening mechanism 830 to the top part 804, while all these elements are still submersed in the fluid 830. Then, the entire system is transferred into another container 920, that is filled with water 922, for removing any oil remaining on the system, as illustrated in FIG. 9E.

The assembled system is shown in FIG. 9F, with the node 100 fully immersed in the liquid 820, which is hold by the top part 804 and the flexible part 802 inside the chamber 801. The system 890 is kept in air for a given time, for example, one hour, for identifying any oil leaks. If any leak is observed, the system needs to be sealed to prevent the leakage of the oil in the seawater. When the system 890 is deemed to be leak free, the system can now be deployed to the ocean bottom, as shown in FIG. 9G, for collecting data.

The data collected with the node 100 may include temperature, pressure, salinity, electric conductivity, salinity, turpitude, depth, radioactivity, particle motion and/or acceleration, etc. Any other parameter that may be measured with a sensor may be measured with the node 100 as long as a corresponding sensor is attached to the digital or analog electronic board.

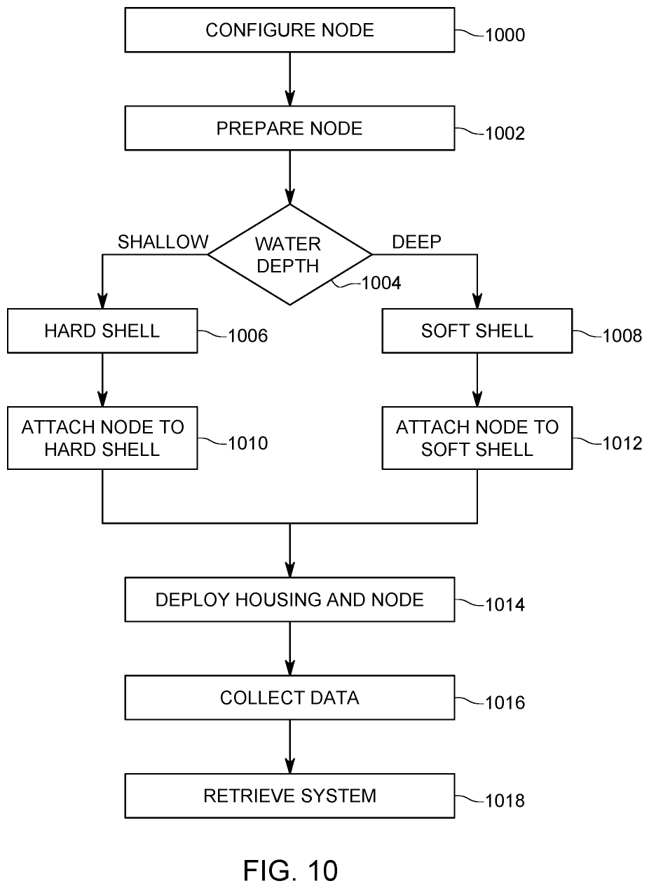

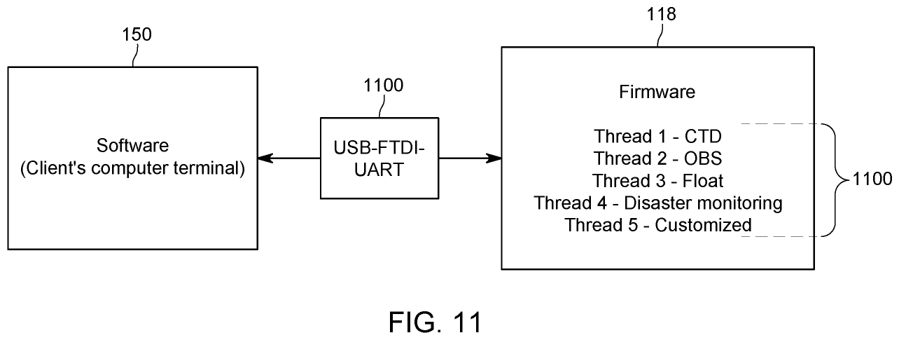

A method for measuring one or more water parameters with the node 100 is now discussed with regard to FIG. 10. In step 1000, the node 100 is configured based on the required parameters to be measured. For example, the analog electronic board 140 and the digital electronic board 130 are attached to the power board 120 and the communication board 110. Then, in step 1002, the selected node is prepared for deployment. This means that the battery of the power board is charged, the memories of the analog and digital boards are cleaned of previous data, the computing devices are tested, and one or more software threads are loaded into the computing devices 118, 128, 138, and/or 148, from the external computing device 150. In this regard, one or more of the computing devices of the node 100 contains an embedded operating system with pre-configured threads. A thread is a piece of software that is compatible with the firmware of the electronic boards of the node and which instructs each computing device what sensor to use, for how long, whether to filter the recorded data between certain ranges, etc. This means that if a customer selects to use a digital temperature sensor that is associated with the digital board, but not a digital pressure sensor that is also associated with the digital board, a corresponding thread instructs the computing device of the digital board to use the temperature sensor but not the pressure sensor. Thus, the user selects from the external computing device 150 which threads to implement, and the external computing device transmits through a wired or wireless interface 1100, as shown in FIG. 11, an instruction to the computing device 118 of the node 100, to active the selected threads 1110. Each thread may implement various functionalities. For example, a first thread Thread1 may instruct the node 100 to measure the conductivity-temperature-depth (CTD), a second thread Thread2 may instruct the node to behave as an observatory, a third thread Thread3 may instruct the node to behave as a float, a fourth thread Thread4 may instruct the node to perform functions associated with disaster monitoring, a fifth thread Thread5 may be customized by the user, for example, the thread may instruct the node to surface after 3 days, another thread may instruct the node to activate specific sensors, etc. While these examples are very simplistic, those skilled in the art would understand that this step affords the users to tailor the functionalities of the electronic boards and associated sensors with their specific needs.

In one application, the communication board has a communication component, for example, acoustic modem, that allows the nodes to “talk” among themselves, exchange information and/or data, and organize themselves to act as an Eulerian and/or Lagrangian sensing node system. After selecting the sensors to be used, the system will also check that these sensors are operational and their data is correctly acquired by the computing devices and stored locally in the local memories.

In step 1004, the operational depth of the node is input by the user and a decision is made to use a hard housing for shallow waters or a soft housing for deep waters. If the operation in the shallow waters is selected, the method advances to step 1006, where the hard shell housing 500 is selected. However, if the operation in the deep waters is selected, the method advances to step 1008, where the soft shell housing 800 is selected. If the hard shell housing is selected, the method advances then to step 1010, in which the node 100 is attached to the hard shell housing 500, as illustrated in FIGS. 7A to 7D, as previously discussed. However, if the soft shell housing is selected, the method advances to step 1012, in which the node 100 is attached to the soft shell housing 800, as illustrated in FIGS. 9A to 9F.

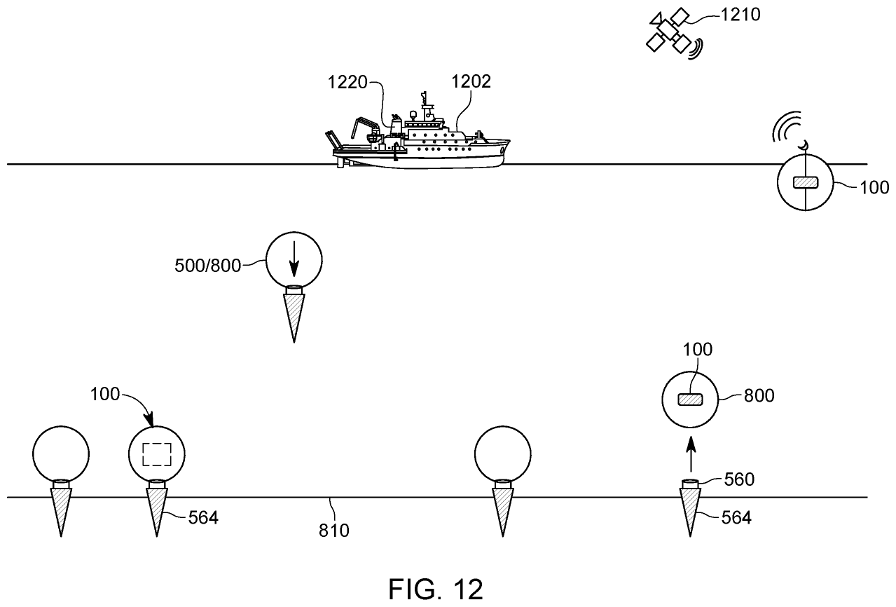

Irrespective of which housing is selected, the node and the housing are then deployed in step 1014 into the water, as illustrated in FIG. 12, for example, from a mother vessel 1202 if deep water deployment has been selected. FIG. 12 shows the mother vessel 1202 deploying plural nodes 100 and housings 800 into the water. The nodes and housings travel to the ocean bottom 810, where they may directly contact the soil around with the flexible part 802.

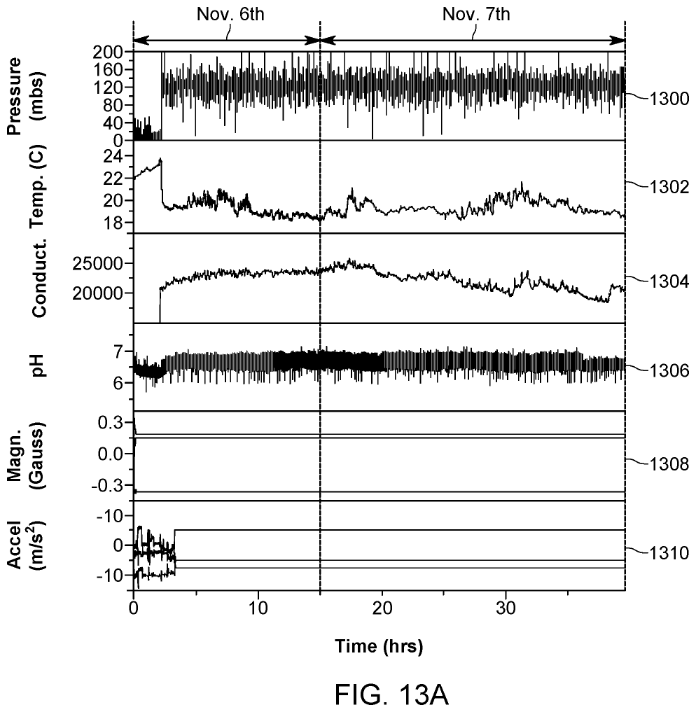

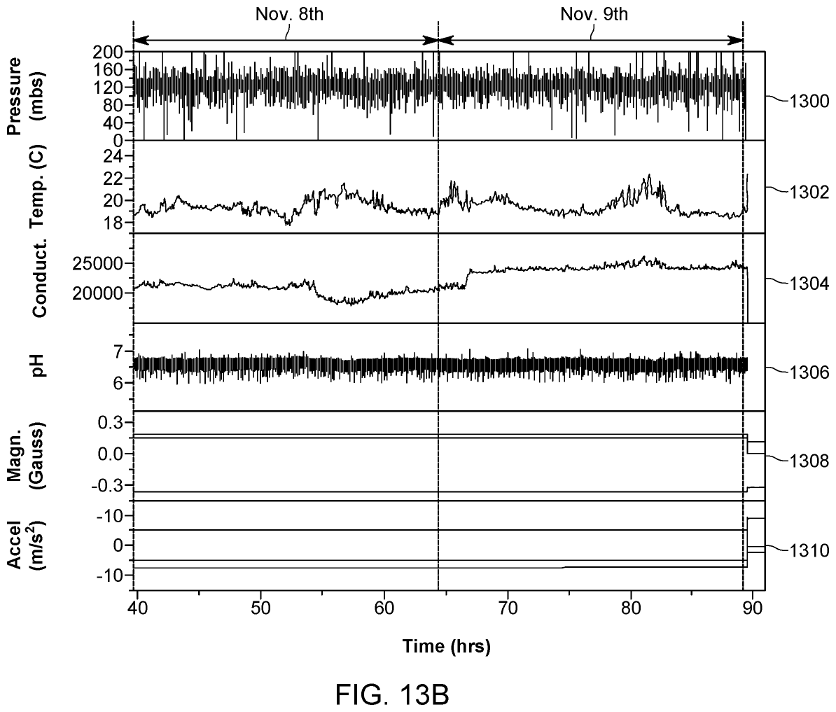

In step 1016, measurements are collected with the available and initiated sensors. The sensors may be configured to start recording the data when contact with the ocean bottom is achieved, or when a certain depth is reached, or based on a timer that counts a predetermined time, or when in contact with the water, etc. The collected data is stored in the local memories associated with the electronic boards. FIGS. 13A and 13B show actual data collected with such a node, and the data includes pressure 1300, temperature 1302, electrical conductivity 1304, pH 1306, magnetic field 1308, and three dimensional acceleration 1310.

In step 1018, the system is retrieved. In one application, the detaching mechanism 560 is instructed by the computing device of the power board or the communication board to release the cable 562, as shown in FIG. 12, so that the weight 564 is not holding back the system. The detaching mechanism 560 is activated by a corresponding computing device based on a timer, an acoustic signal received from the mother vessel, etc. The detaching mechanism 560 may also be left behind, together with the weight 564. Once at the surface, each node 100 may communicate via satellite 1210 its GPS location and/or stored data to the mother vessel 1202 and after the node is retrieved on board of the vessel or in a processing facility located on land, the user connects the node to a server 1220 via watertight connectors to gather the measured data, check for the general status of the node, recharge its battery, and set it to sleep mode until the next deployment.

Thus, according to this method and the structure of the node and its housing discussed above, the system may achieve one or more of the following advantages: the system is hybrid, i.e., it is suitable for both shallow and deep deployment, the system is modularized, i.e., can be internally segmented based on its mission objectives, the system is tailorable and re-configurable as desired by the user, the system is multi-functional as several sensors can provide a multi-dimensional study, the system may be implemented as an affordable network of independent stations, the system is robust, is supportive of distributed-point sensing, has the capability of plug-and-play with a wide variety of sensors and electronic boards, the system can be made of plural stand-alone nodes, the system is flexible in terms of its sensing capabilities and deployment options, the system is applicable for short-to-long-term deployments, the system is configured to have local data storage capabilities, the system can communicate with a satellite for data retrieval or providing direct readouts, the system has a compact size, and the system is recoverable and re-utilizable.

The disclosed embodiments provide a more versatile node for recording water and sediment related data, either in a shallow water or deep water environment. This data may be related to geoscience, ocean science, environmental, biology, archeology, petroleum engineering, etc. It should be understood that this description is not intended to limit the invention. On the contrary, the embodiments are intended to cover alternatives, modifications and equivalents, which are included in the spirit and scope of the invention as defined by the appended claims. Further, in the detailed description of the embodiments, numerous specific details are set forth in order to provide a comprehensive understanding of the claimed invention. However, one skilled in the art would understand that various embodiments may be practiced without such specific details.

Although the features and elements of the present embodiments are described in the embodiments in particular combinations, each feature or element can be used alone without the other features and elements of the embodiments or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

### REFERENCES

[1] Barnes, C. R., Best, M. M., Johnson, F. R., Pautet, L., & Pirenne, B. (2013). Challenges, benefits, and opportunities in installing and operating cabled ocean observatories: Perspectives from NEPTUNE Canada. IEEE Journal of Oceanic Engineering, 38(1), 144-157.
[2] Beranzoli, L., Braun, T., Calcara, M., Casale, P., De Santis, A., D'Anna, G., & Frugoni, F. (2003). Mission results from the first GEOSTAR observatory (Adriatic Sea, 1998). Earth, planets and space, 55(7), 361-373.
[3] Favali, P., & Beranzoli, L. (2006). Seafloor observatory science: A review. Annals of Geophysics, 49(2-3).

1. A system for collecting ocean data, the system comprising:
a node having one or more sensors for collecting the ocean data;
a hard shell housing configured to receive the node; and
a soft shell housing configured to receive the node,
wherein the node is placed into an interior chamber of the hard shell housing for shallow waters operations and the node is placed into an interior chamber of the soft shell housing filled with a dielectric liquid for deep waters operation.

2. The system of claim 1, wherein the hard shell housing is made of first and second mating hard shells, and at least one of the first and second hard shells includes a clamping mechanism for clamping the node.

3. The system of claim 2, wherein the interior chamber of the hard shell housing is under vacuum after the node is clamped to the interior chamber.

4. The system of claim 3, wherein the vacuum maintains the first and second hard shells attached to a common o-ring and seal the interior chamber from the ambient.

5. The system of claim 4, wherein a subset of the one or more sensors is located on an outside surface of the first or second hard shell.

6. The system of claim 5, further comprising:
a detaching mechanism attached to the hard shell housing; and
a weight attached to the detaching mechanism and configured to sink the system in water.

7. The system of claim 1, wherein the soft shell housing is made of a flexible part that transmits a water pressure to the interior chamber, and a second part that is connected to the flexible part to seal the interior chamber from the ambient.

8. The system of claim 7, wherein the interior chamber is filled with a dielectric liquid and the node is fully immersed in the liquid.

9. The system of claim 8, wherein a subset of the one or more sensors is located on an outside surface of the second part.

10. The system of claim 7, further comprising:
a clamping mechanism that attaches the node to the top surface.

11. The system of claim 7, further comprising:
a fastening mechanism that attaches the flexible part to the top part.

12. The system of claim 7, further comprising:
a detaching mechanism attached to the soft shell housing; and
a weight attached to the detaching mechanism and configured to sink the system in water.

13. The system of claim 1, wherein the node comprises:
a power board configured to supply power;
a communication board configured to provide external communications;
an analog board connected to analog sensors for collecting a first part of the ocean data; and
a digital board connected to digital sensors for collecting a second part of the ocean data.

14. The system of claim 13, wherein the power board, the communication board, the analog board, and the digital board are configured to attach to each other through an electrical connector and a mechanical connector so that the four boards form a stack, and the four boards are interchangeable.

15. The system of claim 14, wherein each board includes a corresponding computing device, and each computing device is configured to respond to a thread to activate or inactivate corresponding elements located on the board.

16. A method for collecting ocean data, the method comprising:
configuring a node with one or more sensors for collecting the ocean data;
selecting, based on a water depth at which the node operates, a hard shell housing for shallow water operation, and a soft shell housing for deep water operation;
attaching the node to an internal chamber of the selected hard shell housing or the soft shell housing;
deploying the node in the water; and
collecting the ocean data with the one or more sensors.

17. The method of claim 16, further comprising:
attaching a first hard shell to a second hard shell to form the hard shell housing; and
clamping the node to one of the first or second the hard shell.

18. The method of claim 17, further comprising:
reducing a pressure of the interior chamber of the hard shell housing to connect the first hard shell to the second hard shell.

19. The method of claim 16, further comprising:
attaching a flexible part, which transmits a water pressure to the interior chamber, to a top part to form the soft shell housing.

20. The method of claim 19, further comprising:
filing the interior chamber with a dielectric liquid so that the node is fully immersed in the liquid.
